(19) United States
(12) Patent Application Publication
(10) Pub. No.: US 2012/0179558 A1
(43) Pub. Date: Jul. 12, 2012

(54) System and Method for Enhancing Electronic Transactions

(76) Inventor: Mark Noyes Fischer, Boulder, CO (US)

(21) Appl. No.: 13/287,119

(22) Filed: Nov. 1, 2011

Related U.S. Application Data
(60) Provisional application No. 61/409,264, filed on Nov. 2, 2010.

(51) Int. Cl. G06Q 30/06; G06Q 40/00

(52) U.S. Cl. 705/16; 705/26.41; 705/44

(57) ABSTRACT

A system and method that enables a consumer or merchant to configure their own respective requirements for using and accessing one or more financial accounts in connection with a financial transaction between a consumer and a merchant. Requirements can include any number of factors including the credit profile of the user, the size of the transaction, the location of the merchant or user, the device used by the user or merchant to perform the transaction. Once requirements have been met for at least one financial account, permitting the completion of a financial transaction using one or more of the financial accounts that have had its requirements met.

### PRIORITY

This application claims the benefit of a provisional application filed on Nov. 2, 2010, entitled “System and Method for Enhancing Electronic Transactions” and assigned EFS provisional application number Ser. No. 61/409,264.

### FIELD OF THE INVENTION

This invention relates to the field of electronic transaction management and is directly applicable to online commerce and security and more particularly to a method and system for enhancing electronic transactions in an online and mobile environment.

### BACKGROUND OF THE INVENTION

Like any business, online commerce has many obstacles. Though they may present themselves differently than a brick and mortar establishment, many of these challenges are rooted in the same fundamental issues of trust, communication, and convenience. Creating a profitable online business with a positive reputation requires the ability to navigate these challenges while providing customers with the best online shopping experience available.

A big part of that shopping experience starts with trust and can be broken into two parts: trust that you are a credible and reliable merchant, and trust that the information I provide you will be safe and secure. As to the latter, various standards and rules have been implemented by the payment industry, which require specialized security and privacy adoption. In particular, the Payment Card Industry Data Security Standard (PCI DSS or PCI) is a set of requirements designed to ensure that ALL companies which process, store or transmit credit card information maintain a secure environment. Unfortunately, the requirements that must be met in order to be PCI compliance are very high. Merchants that are small or mid-sized often have a difficult time justifying the expense of not just getting certified—but remaining certified. While such an approach may give the customer a sense of security, the additional cost structure makes it untenable for most merchants.

One solution to this problem has been hosted online payment systems. In this model, a third party, such as PayPal®, holds the credit card (and therefore meets the PCI compliance requirements) and enables a user to send money to the merchant electronically. The problem of course is that these types of payment platforms are “closed,” meaning that as a merchant, one must set up an account with the only available provider. On a similar note, running advanced transactional operations such as repeated sales or delayed charging for shipping becomes time consuming and delays consummation of the transactions. In addition to being inconvenient, such closed systems also charge enhanced fees and limit the merchant's ability to create automated transactions. In other words, the current solutions engender trust, but in the process sacrifice convenience and increase transactional costs.

Finally, the current online commerce systems are built around an analog model. In essence, I enter single card data, and that card is either approved or not approved for the entire amount. I am either approved to make a transaction or I am not approved. It is either a 1 or 0. This structure prevents more dynamic payment management and also makes personalization difficult (if not impossible) to implement.

What is needed, then, is a method and system for effectuating financial transactions that enables a more flexible payment methodology, an open platform that can connect any number of different payment platforms, and a robust API that enables any website owner to enable commerce—whether online or offline—with greater convenience, that is also secure and reliable.

### SUMMARY OF THE INVENTION

The current invention provides a system for enabling a broader array of financial account management, payment options and security options, which is nonetheless highly convenient. The first aspect, financial account management, is rooted in the development of a “network neutral” e-wallet.

In the preferred embodiment, this includes the option to enter payment information on multiple account types. The present invention enables a customer to enter in account information on all there accounts whether that account is a credit card account (the typical type of account used by merchants online), AC H/checking accounts, online bank accounts (such as PayPal®), or any other type of financial account. In other words, the present invention provides a comprehensive way to map all financial accounts into a single location. On the other end of the system, merchants can likewise map in all of the methods by which they may be paid, including all merchant accounts, ACH accounts, Bank Account Information for Wire Transfers, Gift Card/Loyalty Card systems, and any other system which allows the merchant to engage in commerce.

Once each of those financial accounts have been entered, it is critical that they be secured. In the current model, a credit card is validated by confirming zip codes and/or a 4 digit pin associated with the account. While this is certainly a reasonable starting point, the continued rise of online piracy and fraud suggest that the current single password/pin system is not sufficient to prevent misuse. As a result, the second component of the preferred embodiment of the present invention is configurable security. In essence, rather than have the bank or financial institution decide on your security, the present invention allows the customer to select the code, passwords or other mechanisms that will be required in order to unlock one or more “approval” levels. This could be account specific, based on amounts, location, merchant type, or any other variable that defines the “context” of the transaction.

For example, a customer could elect to require a four-digit pin and a special passcode in order to permit any transactions over $100. In the event that the transaction is over $500, an additional code or passkey may be required. Similarly, if a customer is executing a transaction with a merchant that is in a higher risk industry (such adult products), the security requirements could be enhanced to prevent fraudulent misuse. In other words, the totality of the circumstances that define the transaction—from the person that initiated it (owners vs employees; children vs wife), the device used (mobile vs PC), it's location (near home city vs traveling) as well as the identity, type and frequency of interaction with the merchant can all be used to help determine not simply whether or not the transaction is approved but rather the number and type of security protocols that will need to be followed in order to finalize the transaction. In a very real sense, then, the consumer (and merchant) are now given the tools to help define the gateways and protocols which will be applied to each of their financial accounts and the context under which they want to make a transaction either easier or more difficult to execute.

The present invention further provides a set of tools and capabilities for making these transactions easier. In one embodiment of the present invention, the customer not only links each key financial account but also allows the system to pull information regarding those accounts in order to optimize cost, convenience and payment flexibility. This feature can be best understood by imagining a common online transaction. I buy a stereo for $500. In the prior art, I would enter my credit card or otherwise link a payment account and send $500. If the account I used does not have $500, the transaction is declined. Now consider a situation in which that same customer is using the current invention. By linking several accounts, the payment platform can now identify how much credit or balance is available across each account as well as which payment methods on file may interact with the specific merchant in question.

After the customer has met each of the security requirements for the respective accounts, the payment engine can provide one or more options for performing the requested transactions including permitting $250 to be charged to a checking account, $100 to be charged to a VISA card and $150 to be charged to a Mastercard. In other words, the system can provide a flexible framework for completing a single transaction involving multiple financial accounts—with each having their own unique security or approval requirements. While these same transactions could be user controlled, the system of the present invention can also be configured to propose one or more “optimal” transactions based on interest rates, transaction fees, available balances or any other factor.

On the merchant side, the present system and method further provide conveniences around ease of administration as it provides a simple open API to engage with multiple payment receipt services and otherwise enables a merchant to be largely independent of the means that a customer may employ to pay for services. For example, Merchants can use a simple configuration page to not only specify which payments they receive but also what additional requirements must be met to meet the transaction. Finally, by using simple java or other “contained” code, the merchant can add the payment functionality to their website without altering any code whatsoever. Indeed, the javascript in the preferred embodiment would “pull” any calls or fields it would need to complete a transaction on behalf of the Merchant depending on how the merchant had configured the services from a financial software server but again—the other code would otherwise remain unchanged. This is a significant advantage over current systems from both ease of administration and simplicity.

While these transactions have been framed as if they are online, the same security rules and optimization algorithms could also be applied to payments using a mobile device. For example, using one or more of the current available mobile payment platforms, a user could transmit payment for in-store purchases and pay for those purchases using a multiplicity of financial accounts. These could be processed via an online server or could instead be sent or transmitted using wireless or near field communications capabilities such that a merchant can receive payment confirmation from multiple accounts without running a single credit card. Using a mobile device would further permit more creative uses of the validation requirements linked to a financial account. For example, a user may need to execute a gesture (such as twirling in a circle or making an infinite shape with a smartphone) as part of the mechanism for approving the transaction. Again, in each case, the customer is provided with the power to set and configure those requirements according to their desired level of convenience and security.

While I have summarized a few of these capabilities with reference to the customer, the merchant could also modify these same configurable security and payment options. For example, since many merchants do not like to pay the 2-3% transaction fees often charged by credit card companies, they could limit payment options to ACH or other cash-based accounts with lower fees. They could also limit use of certain financial accounts that are more prone to fraud or misuse. For example, a merchant could permit the first $100 of a transaction to be paid using any means but transactions over $500 could only be processed using a checking account. Merchants can also transfer the cost of those fees by offering a 3% discount to members that pay for merchandise with cash. In such a case, the payment system of the present invention would enable a customer to not only optimize use of their financial accounts but also optimize or minimize the fees and identify the financial accounts that the merchant has agreed to accept. In this way, a merchant can set their risk threshold, reduce fraud and minimize transactions costs while the customer can optimize their buying behaviors, using security rules that they define and have immediate awareness of the payment methods and accounts that can be used to reimburse the merchant. While this was intended to provide an overview of the invention, there are many other features, functions and variants that are possible using the current system which shall be explained in greater detail with reference to the figures below.

### BRIEF DESCRIPTION OF THE DRAWINGS

FIG. 1A illustrates the prior art method for managing electronic transactions

FIG. 1B illustrates the payment flexibility of the open payment network of the current invention

FIG. 2 illustrates sample personalized security filters of the present invention.

FIG. 3 provides a screenshot of the daily volume throttle capability of the current invention

FIG. 4 illustrates a fee payment configuration screen.

FIG. 5 illustrates a sample embodiment of a payment page in communication with the InspirePay server

FIG. 6, a sample screen shot of one possible secondary authentication 204 means is shown

FIG. 7 provides a sample screen that could communicate with the InspirePay server to enable payment as well as display system fees per card type.

FIG. 8 is a diagram illustrating one mobile embodiment of the invented financial payment and configuration system of the present invention.

FIG. 9 illustrates a method for enhancing financial transactions with automated escrow protection.

FIG. 10 illustrates one sample embodiment of a partial payment suggestion method of the present invention.

FIG. 11 illustrates a sample fraud algorithm that can be used to modify the transaction to reflect one or more risk factors inherent in a linked financial account.

FIG. 12 is a diagram illustrating one method for providing a card holder with transactional security through buffered tokenization

FIG. 13 illustrates a method for extending an open authentication network using advanced authentication method of the current invention.

FIG. 14 provides a screenshot illustrating configuration of the universal authorization rules of the present invention.

FIG. 15 illustrates a block diagram of a transaction flow that includes the transaction queue of the present invention.

FIG. 16 illustrates a sample Merchant configuration page that can be used to configure the open API of the present invention.

### DETAILED DESCRIPTION OF EXAMPLE EMBODIMENTS

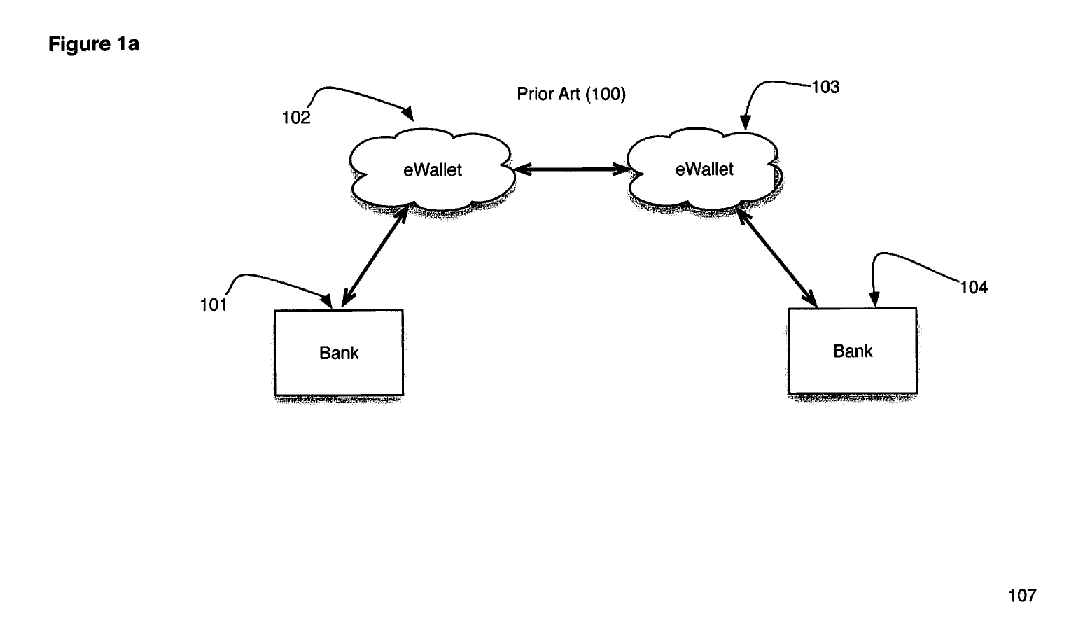

FIG. 1A illustrates the prior art method for managing electronic transactions. In this example, Bank 101 (the customer's bank) transmits funds to an eWallet account 102. This is the method used by PayPal® to fund an account. In order to receive the money, a merchant must also have an eWallet account 103 linked to their Bank account 104. As explained above, this type of transaction is a “closed” network model and not only requires that both parties be on the same network, but also generally limits payment options to a single corresponding bank or other financial account.

FIG. 1B illustrates the payment flexibility of the open payment network of the current invention. In this case, InspirePay serves as an intermediary that can link to multiple accounts and multiple account types. More specifically, a customer may link Bank A 106, a Bank account B 108, a credit card 109 and a rewards card 110 all to the InspirePay 105 account. Similarly, a merchant can arrange to have one or more accounts which can receive funds from the InspirePay 105 service. For example, a customer may want to split a transactions across Bank A 106 and Bank B 108. Or, instead, the Customer may want to simple use a credit card 109 to pay the merchant account 112 directly. Furthermore, the merchant can configure the account that receives the funds to be a credit card 113 either right from the first dollar or only after the Merchant Account 112 has received $500 in total transactions dollars.

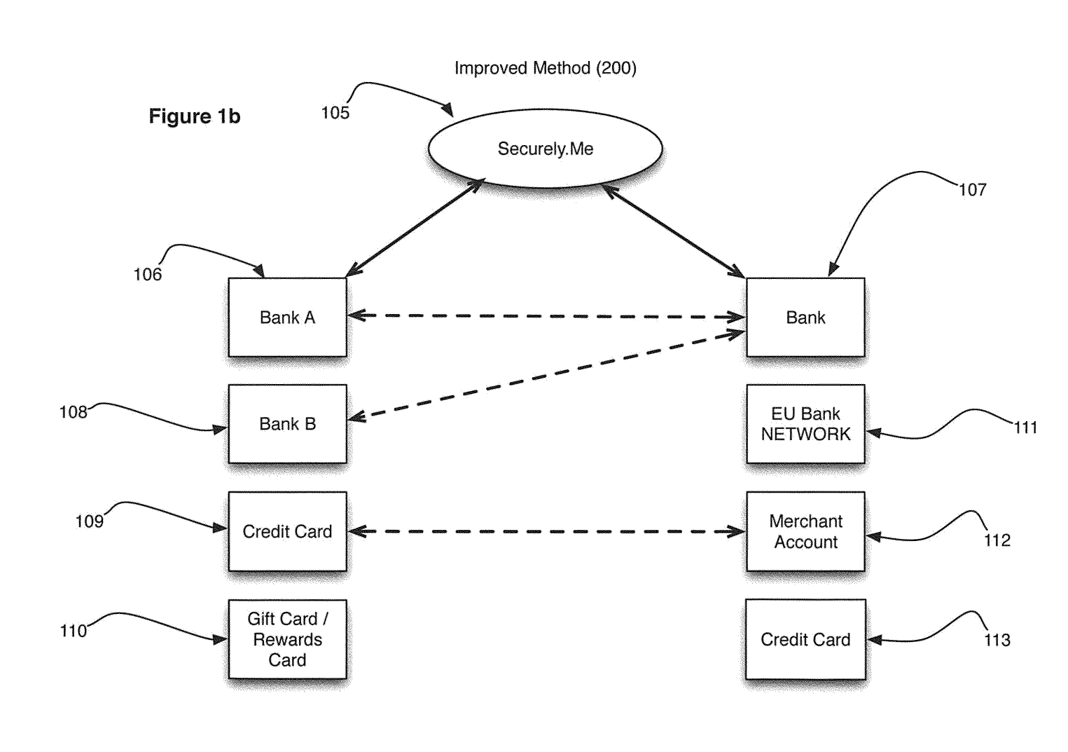

Referring now to FIG. 2, the security filters of the present invention are shown. As mentioned above, one of the most powerful features of the current invention is the ability to personalize and contextualize financial transactions. Once a user has registered on the InspirePay server 105, they can select their preferred means for primary authentication 200, secondary authentication 202, and mobile authentication 206.

Primary authentication 200 is the first layer of the security filter and generally involves linked the financial account to an identity. In FIG. 2, the three methods of primary authentication 200 illustrated include the use of username/password, an OpenID or an Open Social authentication 201. In each case, a user can decide which of these primary authentication types are preferred or indeed of any of the three can be used. In the case of Open Social, for example, a person could use their Facebook® account to authenticate themselves. As with any of the authentication types which are set forth in FIG. 2, the authentication type required could also depend on one or more other contextual cues including whether it is a local vs. remote transaction, online versus offline, by amounts, or any other factors that could influence the reliability and trust associated with the merchant. For example, the time of day, the history of transactions, the means for verification, the diversity of verification means (i.e. did they answer a security question on one log-in and then use a pass-code for another) and any number of related contextual cues could be used to modify the “risk” associated with a given transaction and therefore result in a higher or lower overall verification score.

Once the customer has met the primary authentication 200 requirements, they can now select the secondary authentication requirements. For example, in the prior art, a pin number 203 could be used to provide secondary confirmation. This is what occurs, for example, when a customer wishes to withdrawal cash from an ATM. The present system enables several additional secondary authentication features. For example, the customer can configure whether a given transaction will require the accurate answer to one or more security questions 204 before a transaction can be approved. These can be user-selected questions or based on a common set of questions used by the system to authenticate. Furthermore, the order in which the security questions 204 are presented could be a further security feature. For example, if a customer is approving a transaction with a fraudulent merchant and the questions that they receive are either not accurate or not presented in the correct order, the customer could cancel the fraudulent transaction. Finally, additional mechanism, such as RSA Secure ID, security tokens, key fobs, or other physical tools 205 for confirming identity could be used as secondary authentication 202 means. Once again, the customer can select and secure their accounts in whatever manner that they wish. Rather than be a one size fits all, the customer can now decide which accounts present a greater risk and therefore justify more security before being approved. In this way, a customer may personalize their entire financial framework for each type of account, card or merchant.

It should be noted that while FIG. 2 provides an embodiment for verification with a financial services provider, this same rigorous identity management process could be applied to any number of electronic transactions including access to corporate IT, government records, medical/health records, and other similarly “confidential” transactions where identity is required. As explained above, each of these settings may also include one or more tasks that can only be performed responsive to meeting a “level” of authentication. In the medical records example, a simple password and username may be sufficient for access. In the case of a digital signature for a legal document, validating any number of user defined security prompts may be required in a user specified order, such as a pin number, followed by one of three questions, followed by an image based puzzle.

Finally, FIG. 2 illustrates a few sample authentication means that can be enabled on a mobile device. For example, the customer can elect to require facial recognition 207, voice recognition 208, and/or motion recognition 209 before permitting a mobile transaction. Given the risk of losing a phone, these additional layers can help protect the customer against theft of the device by leveraging the unique capabilities of today's smart phones. It should be appreciated that these authentication means 200, 202, 206 are not intended to be exhaustive but rather illustrative of the way in which a customer can choose to configure accounts in their own unique way. By combining personalization and security, the customer is given the power to define their risk and manage it as they see fit.

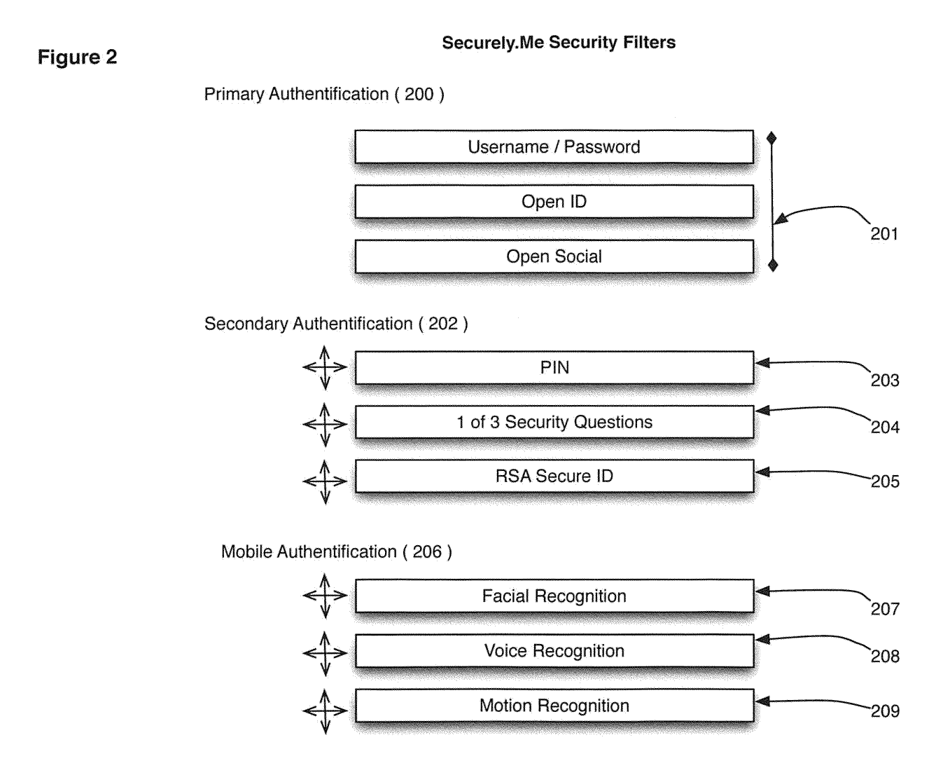

FIG. 3 provides a screenshot of the daily volume throttle capability of the current invention. In this instance, the costumer is offered the ability to set a total daily limit on one or more of their respective financial accounts. In this example, the customer has selected $200 in the Bank Card B daily throttle limit field 301. While not illustrated, the throttle could be linked to one or more of the security configuration settings such that the same account could be approved for up to $200 if only the pin is used but increased to $1000 when a mobile authentication 206 is also applied. This feature would enable a business owner to share some of his security settings with an employee by only sharing a limited set of security authentication mechanisms without placing a cap on his/her own transactions. In other words, the daily limit itself becomes a component of the security protocols around the account and puts a hard limit on any fraudulent activities without limiting all account users.

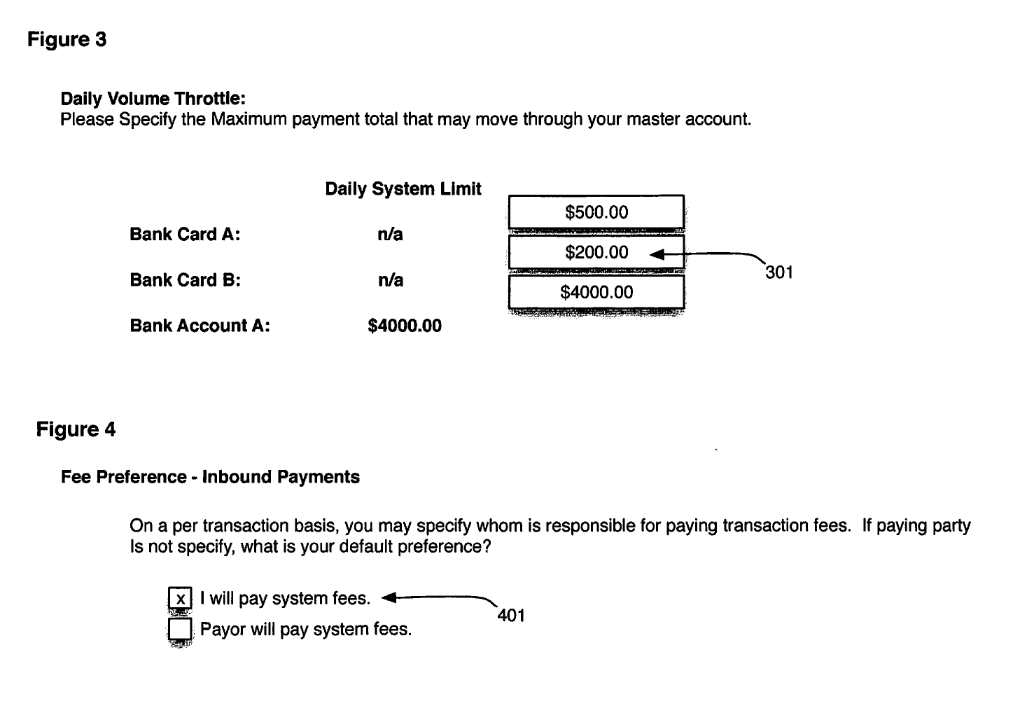

FIG. 4 illustrates a fee payment configuration screen. In this case, the customer or merchant is offered the choice to pay system fees 401 on one or more transactions. While this is illustrated as being applied across accounts, this could also be individually configured for each account. For example, a customer may agree to pay the transaction fees for a credit card but refuse to pay transaction fees for any ACH transfers. Similarly, a merchant may agree to pay fees up to a total daily limit, based on the size of the transaction, the margin of the product or service or other parameters. In such a case, the customer can then be notified that using one or more payment types may result in the payment of transaction fees and can then elect to use one or more other financial accounts to avoid paying the fees or can agree to simply pay the fees as requested. In this way, a merchant can incent customers to leverage payment types and accounts that reduce overall transaction costs and, as a result, can pass that savings on as product discounts or rewards.

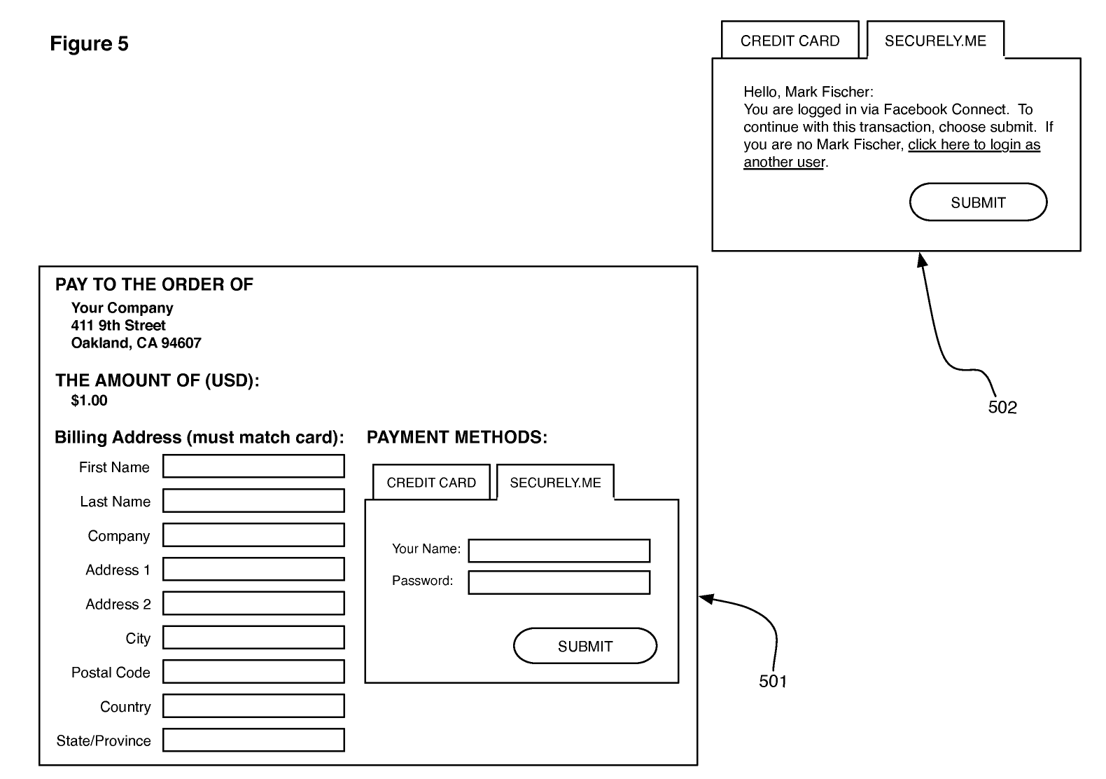

Referring now to FIG. 5, a sample embodiment of a payment page 501 in communication with the InspirePay server 105 is shown. In this case, the customer has logged in using Open Social ID 502 for his primary authentication means. Specifically, Facebook Connect was used to authenticate the user. The information linked to that account could then be used to pre-populate the payment address and other fields in screen 501 or may be an additional security layer prior to the approval of the financial transaction.

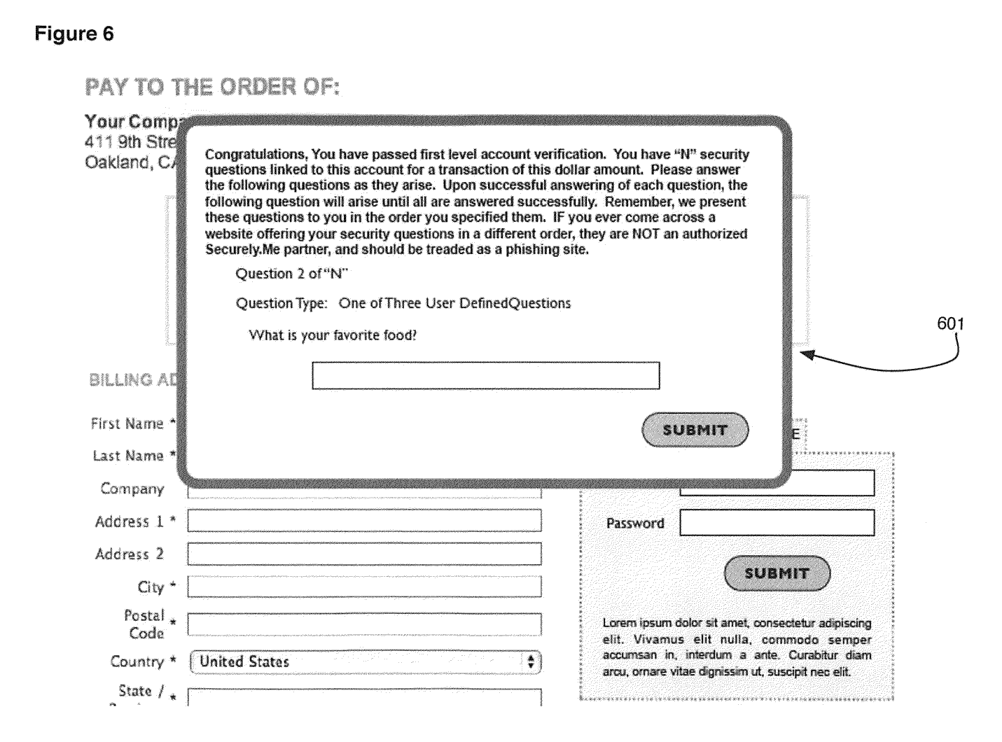

Referring now to FIG. 6, a sample screen shot of one possible secondary authentication 204 means is shown. In this case, one or more questions that were previously configured by the customer are presented via a pop-up window 601 and the customer must answer accurately (and in the order configured by the client) before the transaction is approved. By enabling this level of configuration, a customer can strike their own balance between security and convenience in a personalized way by selecting just 1, 2 or up to “N” different questions that must be answered prior to transferring any funds.

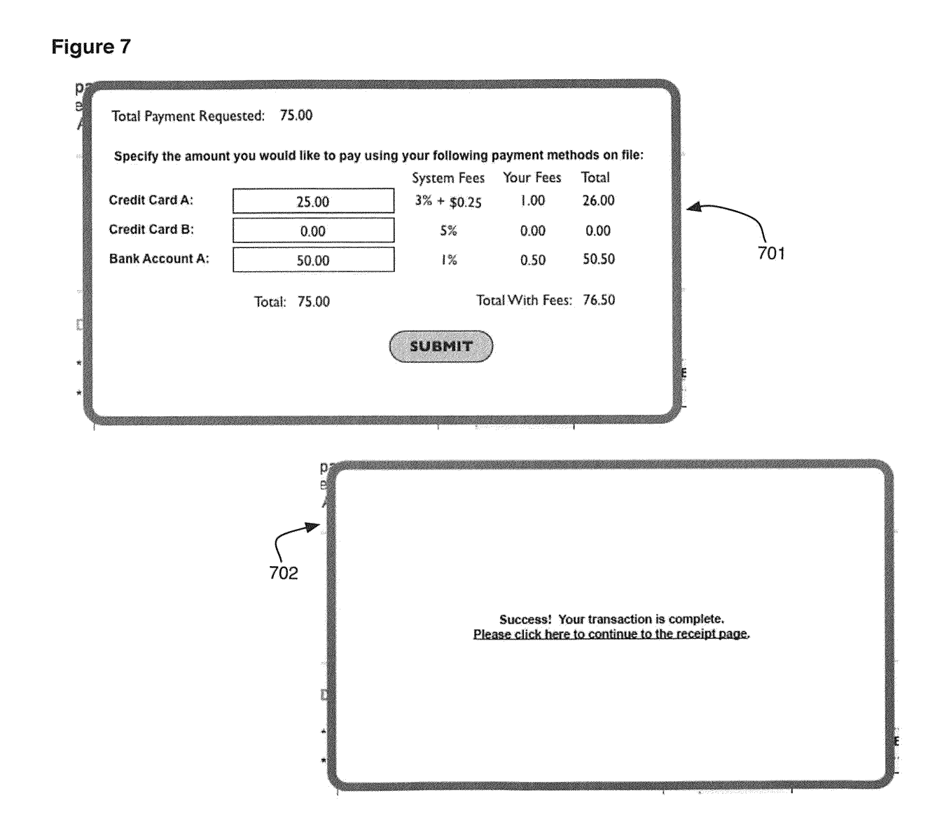

Referring now to FIG. 7, a sample payment screen 701 is shown. In this instance, once the customer has been authenticated, the accounts that are available at that level of authentication are presented along. While it is not illustrated, this payment window 701 could further include information showing the available balances on each account, any transaction fees that may be applicable to use of that account and or other information that would help a customer make an informed and optimal choice concerning payment. In this example, the customer has selected to pay the $75 fee using $25 off Credit Card A and $50 off of Bank Account A. It is important to note that choosing to pay across multiple accounts is seamless for the merchant meaning that the customer's election does not either inconvenience or disrupt the normal payment processing of the merchant. Following the selection of the “submit” key, the customer receives a screen 702 indicating that the transaction was successful.

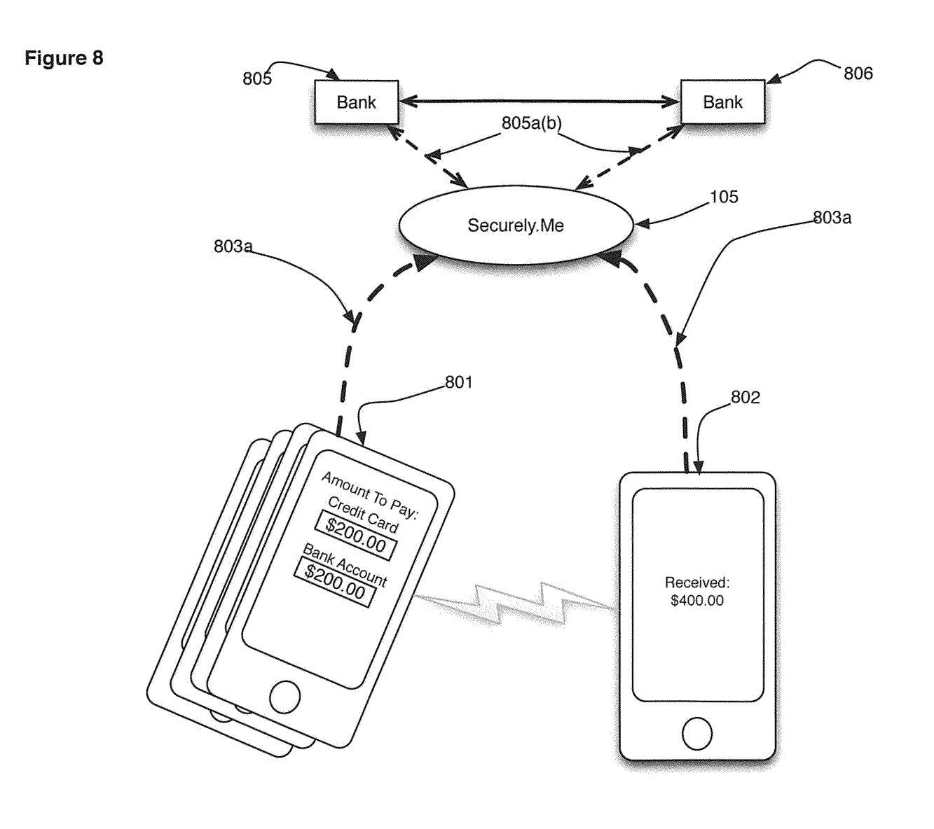

Referring now to FIG. 8, a diagram illustrating one mobile embodiment of the invented financial payment and configuration system is shown. In this example, rather than a pop-up window on a computer, the customer's mobile phone 801 is in communication 803a with the InspirePay server 105. Following appropriate authentication by the customer (as explained above) the customer us provided with account options for payment on the mobile phone 801 screen. As explained above, the customer bank 805 and merchant bank 806 are also in communication 805a, 805b with the InspirePay server 105 so once the customer approves a given transaction, the funds are immediately transferred to the merchant bank 806 and appropriate mobile notification is provided on the merchant's mobile device 802. This is particularly useful for merchants which may not have a permanent physical location such as fairs, farmer's markets, flea markets, art festivals or other settings where payment and receipt can most easily be accomplished using mobile technologies.

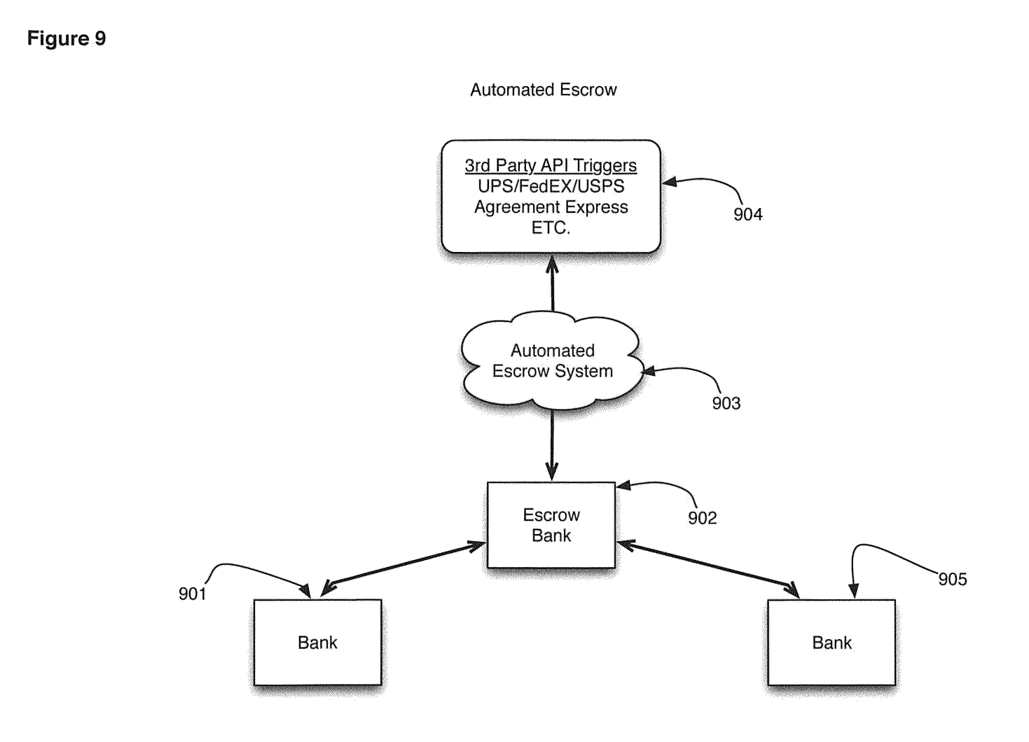

Referring now to FIG. 9, a method for enhancing financial transactions with automated escrow protection is shown. In this example, the customer has approved the transaction and transmitted funds from Bank 901 to the Escrow Account 902. The Escrow Account 902 is further connected to an automated escrow system 903 that is configured to monitor one or more delivery means or other 3^{rd} party API triggers 904 to determine when the fund deposited at the Escrow Bank 902 can be related to the Merchant Bank 905. This would be particularly useful in the online shopping context where it is often the case that funds have been transferred prior to the receipt of the goods. By permitted an automated escrow system 903 to suspend payment to the merchant bank 905, the costumer is protected from merchants that might otherwise try to collect without sending the merchandise. On the flip side, by funding the escrow bank 902 in advance, the merchant also avoids the risk of a non-paying customer. Finally, the customer could also use an escrow to monitor one account for activity and fund the other account. For example, a customer might elect to use their rewards mileage credit card for a transaction but immediately transfer funds from their checking to cover such transaction as soon as it is completed. In this way, one transaction might initiate one or more downstream financial transactions.

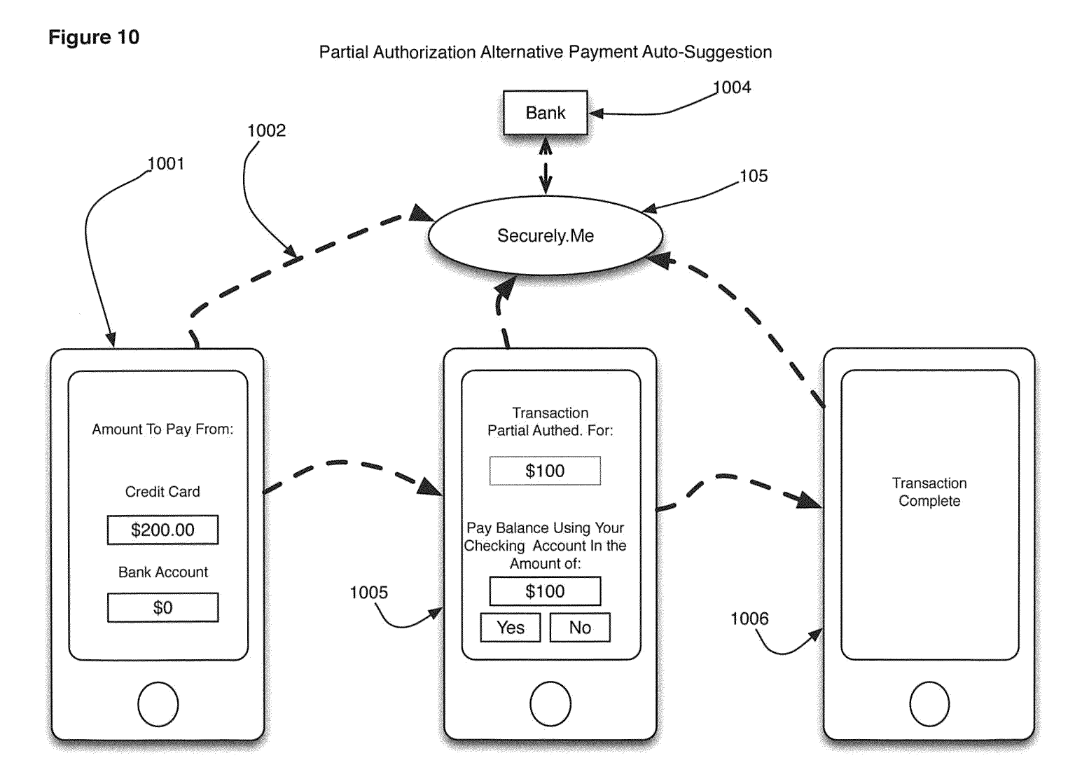

Referring now to FIG. 10, a partial payment suggestion method is shown. In this figure, the customer has initially authorized a $200 payment from the credit card 1002 and that request has been sent to the InspirePay server 105. In this example, the credit card does not have $200 of credit available so the InspirePay server 105 is able to auto-suggest 1005 the portion of the amount that can be paid on the credit card (in this case $100) and suggest the remainder of the payment be satisfied using the account associated with Bank 1004 that is also linked to this customer profile. As a result, in a single step additional, rather than being humiliated by a credit card rejection, the current invention is able to propose workable alternative methodologies using the account information stored on the InspirePay server 105 resulting in a completed transaction 1006.

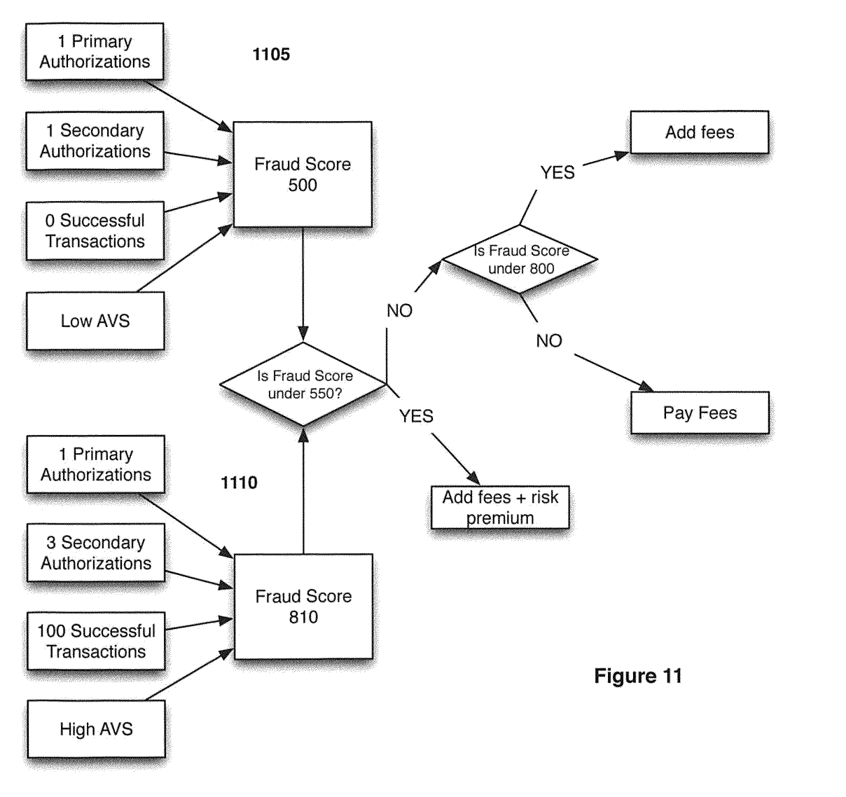

Referring now top FIG. 11, a fraud algorithm method is illustrated that can be used to modify the transaction to reflect one or more risk factors inherent in a linked financial account. In step 1105, a fraud score is calculated by measuring the level of security used to access the account. In the first example 1005, the fact that the required authorizations were relatively weak (1 primary and 1 secondary) and the fact that the account has had zero transactions results in a fraud score of 500. In other words, this financial account is viewed as a high risk account. Compare account 1105 with account 1110. In this case, this account is protected with 1 primary, 3 secondary authorizations, credentials have been verified, it has a high level address verification service (AVS) and has been involved in 100 successful transactions. As a result, it has a fraud score of 810 reflecting a low risk financial account. In this illustrated example, these fraud scores 1105, 1110 are compared with the merchant risk settings to assess whether an additional risk premium would be assessed and who pays the card fees. Since the first account 1105 is considered high risk, the customer is required to pay card fees AND a +3% risk premium. In other words, the customer's actions and security settings impact how risk is allocated as between the merchant and the customer. Since the second account 1110 is considered low risk, that customer not only doesn't pay a risk premium but the merchant pays the card fees as well. This example perfectly illustrates the power of this invention. Rather than treating all customers as equal, the personalization of security settings, verification and transactional history create a more balanced way for both the customer and the merchant to assess and share the risk of fraud in a more meaningful and personalized way.

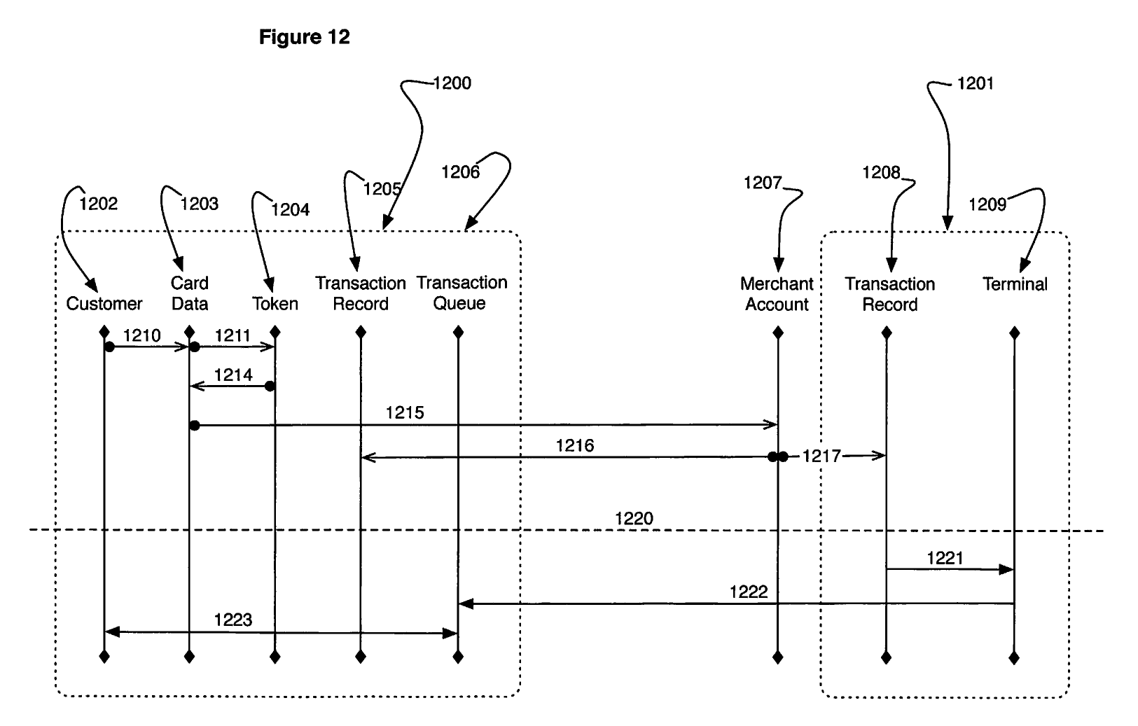

Referring now to FIG. 12, a diagram illustrating two method for providing a card-holder with transactional security through buffered tokenization. The card data 1203, token 1204 and associated transaction records 1205 are all part of the transaction engine as illustrated in 1200. In example one (1210 through 1216), the customer 1202 first creates 1210 a payment request by submitting financial card data 1203. This card data 1203 is submitted 1211 to the transaction engine 1200 and is converted 1213 into a token 1204. The token 1204 can be any non-decryptable piece of data to represent, by reference, the card data 1203. This token 1204 is then stored in a database (not shown) and associated with the customer 1202 (Other examples of 1203 include bank routing numbers, wire transfer data, or any other related type of data to be tokenized). Assuming that the card holder and/or customer 1202 has approved the transaction, the transaction engine 1200 transmits 1215 the token and associated transaction information to the Merchant Account 1207. The merchant account could reside within the same network as the customer 1202 or could be an external financial account. Notice that in the illustrated method, the merchant account itself is outside of 1201, the merchant's user interface. In this case, secure card data bypasses the merchant's user experience, thus clearing them of PCI type requirements, as they are not specifically handling any payment card data directly.

The financial processor 1207 being utilized by the merchant receives 1217 confirmation that a transaction (such as an online payment) has been approved by the customer 1202. A transaction record 1205, 1208 is generated and associated 1216 with the customer 1202 by the Transaction Engine 1200 and associated 1217 with the merchant by the merchant's financial processor 1201a. While not shown, it is assumed that the merchant account 1207 or transaction record 1208 will provide sufficient information for the merchant's financial processor 1201a to associate the transaction record 1208 with the customer (for example, an account number that the merchant has associated with the customer). Using the token in this way avoids disclosing any card data 1203 to the merchant account 1207 while still providing an auditable trail (i.e. the transaction is still associated with a customer 1202 by the transaction engine 1200) in the event that the transaction is later questioned or reversed. Tokenization in this manner is well understood in the payment processing space so while this is one method for enabling cardholder security in accordance with one embodiment of the current invention, many other methods for tokenizing cardholder data may also be used.

Looking at the second method for providing a cardholder with advanced transactional security, 1220 and below show an example of a merchant initiated transaction. If the transaction meets one or more criteria, then it is added to the transaction queue 1206. The transaction queue 1206 provides a way for the primary cardholder to expressly approve or disapprove any transactions. In one embodiment, a notification or alert is transmitted 1223 to the primary cardholder such as an SMS alert or some other near real-time messaging methodology. Furthermore, the primary cardholder could also not only approve the transaction in a queue but could apply the pending transactions to one or more different financial accounts. In other words, not only does the primary card holder have the right to approve the transactions but may also re-route them to accounts that they would prefer to use.

Transactions that would be candidates for the transaction queue 1206 include user-initiated transactions performed in advance (pre-transaction tokenization), in response to a user-initiated when the user is not the primary cardholder (such as a child of the primary card holder), or responsive to the transmission 1222 of a merchant originated transaction. Looking at one specific example, assuming a merchant reviews the days transactions 1208 and notices shipping was calculated improperly on the transaction. They may try and authorize additional money on the card 1221, which is common practice with electronic transactions. Rather than charging the card without the customer's 1202 approval, the transaction 1222 is placed in the consumer's transaction queue 1206. The customer is then notified via 1223, and if the transaction is approved, 1214 and 1215 would follow, resulting in the card being charged the difference, and 1216, 1217 would result in updating transactional records 1205 1208.

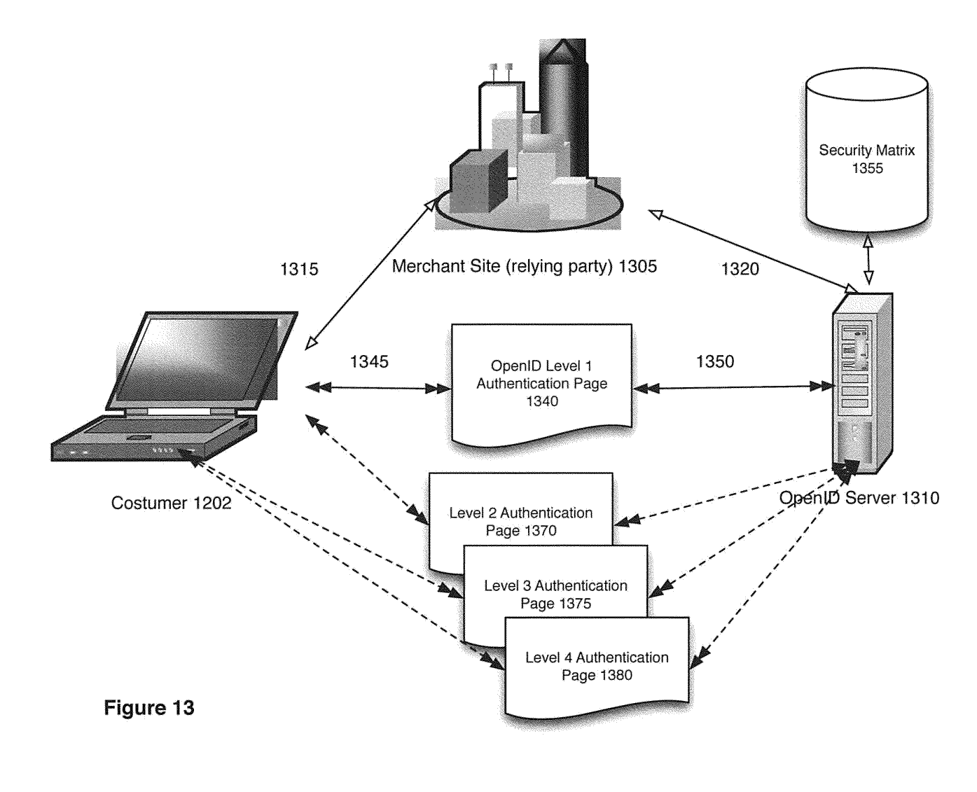

Referring now to FIG. 13, a method for extending an open authentication network using advanced authentication method of the current invention is shown. OpenID and similar digital identity providers allow a user-agent to create a single digital identity that they can leverage for other third party sites. In other words, it is a decentralized way to authenticate the costumer 1202 using an open architecture authentication model.

In this diagram, the customer 1202 visits a merchant website or store 1305 via the communications channel 1315. Responsive to a request by the Customer 1202 to perform one or more services supported by the merchant website 1305 (such as checking balances or paying for an item), the customer must be authenticated and, rather than entering a user name or password for the merchant site 1305, the customer 1202 instead opts to use an OpenID server 1310 for authentication. In this instance, the merchant site 1305 would need to create a logical link to an OpenID server 1310 using communications channel 1320. In the preferred embodiment, the OpenID Server 1310 and merchant site 1305 would have been previously linked and validated using one or more means such as a shared secret that only the Merchant site 1305 and OpenID server 1310 share.

The merchant site 1305 would also have a transaction ID or “association handle” that could be used to identify the customer 1202 and the customer request. The merchant site 1305 would then re-direct the costumer to the OpenID Server 1310. In this instance, the customer 1202 and opened Server 1310 would create a secured communication channel 1345, 1350 and the customer 1202 would be presented with an OpenID level 1 authentication page 1340. Once the costumer 1202 had entered the correct credentials into the authentication page 1340, the OpenID server 1310 would verify the log in using information on the server 1410.

In the current art, if the user login credentials were accurate, the OpenID server 1310 would return the customer 1202 back to the Merchant Site 1305 with the appropriate customer credentials along with information that verified that it was the OpenID Server 1310 (such as the shared secret).

The present invention further improves upon this model by enabling the customer 1202 and merchant site 1305 to create additional levels of authentication depending on the services being requested by the user. In this instance, rather than returning the customer 1202 to the merchant site 1305, the OpenID server 1310 would determine if the customer 1202 or merchant 1305 had an associated security matrix 1355. In this embodiment, the security matrix 1355 would provide a list of any special authentication steps that might be requested by a customer 1202 or the merchant 1305 before the authentication step can be considered complete. For example, a customer 1202 might require that—before credentials could be shared with a merchant site 1305 for purchases over $500—the OpenID server would need to complete level 3 authentication page 1375. This could be based on challenge phrase, an action, the location of a mobile phone associated with the account (for example, confirming that the phone is within 100 meters of the merchant's physical address) or any number of other forms of input whether by computer, in person, on their mobile phone, or any number of other means for verification.

The Security Matrix 1355 could be maintained by a third party (such as InspirePay) or could be hosted and managed by the OpenID provider that also hosts and maintains the opened server 1310. In a preferred embodiment, the Security matrix 1355 would include one or more transaction codes that can be passed by the merchant site 1305 to the opened server 1305 using communications channel 1320 such that the openID server could then associate the transaction code with one or more authentication rules (Universal Authorization Rules) as illustrated in the next figure. A sample XML code that could be transmitted could be to require Auth level 1 for changes to “settings” could be structured as:

<AuthLevel2 title=”settings”>

<rule -type>admin/<rule-type>
<min-auth>1</min-auth>

</AuthLevel2)

It should be understood that the means for sharing the code—whether via XML, an API, or some other means—should be based on the parameters presented to the user during configuration of the Universal Authorization Rules 1355.

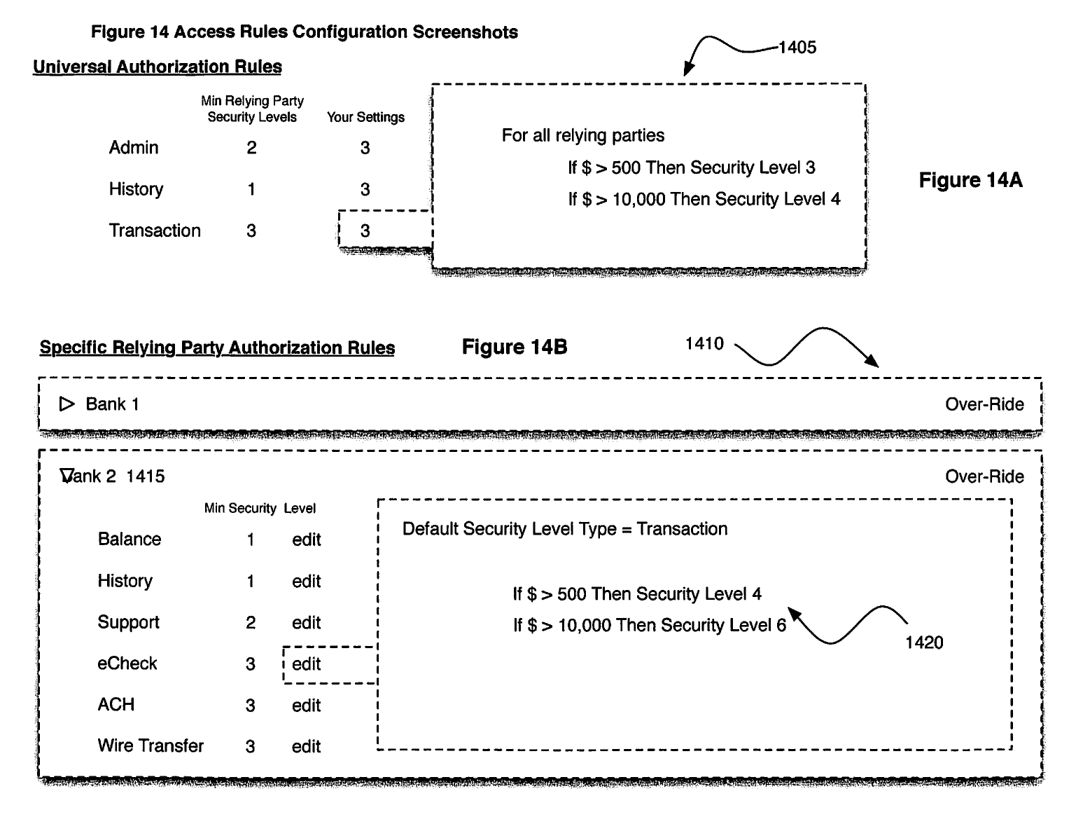

Referring now to FIG. 14, a screenshot illustrating configuration of the universal authorization rules is shown. In this example, the user has selected the security settings associated with approval for one or more “Transactions” 1405. As will be noted, in this instance, the selected settings are the authentication settings being configured by the user. These settings are referred to as “universal” as they will be applied to all financial accounts across the board. The minimum-security levels specified by the relying party to perform transactions on this example is “3”. As explained above, there could be preconfigured challenge questions, passwords and other security protocols that must be followed to achieve level 3 authentication or one or more of these steps could be user defined.

In this example, the security settings 1405 presented to the user would also allow them to set additional restrictions or authentication requirements responsive to the type and size of transaction ($>500). While this example is directed toward payments being made to a relying party, the relying party could also be a provider—such as a bank—that requires authentication prior to permitting one or more operations on a website. In other words, the present invention can support ANY transactions that requires authentication and not just a payment transaction. This approach enables a user to protect and define access to any number of services, transactions, settings, or other sensitive information in a completely flexible way. More importantly, be enabling such a wide array of means for authenticating a user, it is significantly more difficult for a potential fraudster to interfere or otherwise pretend to be a merchant, a user or any other relying party to a transaction.

Referring now to FIG. 14B, a screenshot of a sample page for making party specific authentication rules is shown. First, any parties that rely on authorization from the user are listed. For example, bank 1 1410 might be a financial institution with whom a user has an account. By selecting the button 1410 associated with a bank or institution, a pull down menu 1415 of options are provided that identify each type of transactions that are available for the listed “relying party”. In this instance, “balance”, “history”, “support” “eCheck”, “ACH” and “wire transfer” are available activities that can be configured. In the preferred embodiment, the party specific settings would “borrow” the universal settings described with reference to FIG. 14a above for its “base” settings. For example, in the detailed summary 1420, the security level is already set to “3” to reflect that this settings includes a “Default Security Level Type” that is equal to “Transaction”. The user is then offered the opportunity to add or amend those settings to require additional authentications steps. In this case, the party specific settings 1420 have been modified to require level 4 authentication for transfers of more than $500 and security level 6 to transfer $10,000 or more.

The method and system described above provides a powerful tool for users—whether consumers, merchants, or other related parties—for creating customized approval processes, authentication steps, risk allocation mechanisms (including financial premiums) and any number of other options for enabling a personalized transactional infrastructure using multiple tiers of authentication, across multiple devices (computer, mobile, credit card device), using either an open or closed architecture. Furthermore, each and every one of these options are available for configuration by any stakeholder in the transaction. For this reason, the present invention provides a powerful, flexible and fully configurable means for enabling electronic transactions across multiple stake holders that is simple to use and easy to administer.

It should be clarified that when the application discloses “levels” of authentication: there is no reason that each level needs to correspond to a different additional action. For example, level 6 authentication could involve multiple passwords and challenge questions or it could involve a single step—such as a finger scan or eye scan. In other words, levels can be achieved in a single step (by including technologies that are much more difficult to crack) or it could be a succession of steps.

Additionally, while many of these configurable authentication and approval settings have been described with reference to a buyer rather than a merchant, the same interface could be used by any relying party to create easy to configure and update authentication settings. These could be based on transaction type or even based on other objective factors. For example, if a party being authenticated has not previously been authenticated, the relying party could modify its own authentication rules to require additional steps for the first 5 service requests. Or the relying party could require additional steps in the event that the user is attempting to log in from a remote location rather than a local one. In other words, in combination with the financial management systems described above, any number of potential triggers and authentication steps could be configured on both sides of the transaction.

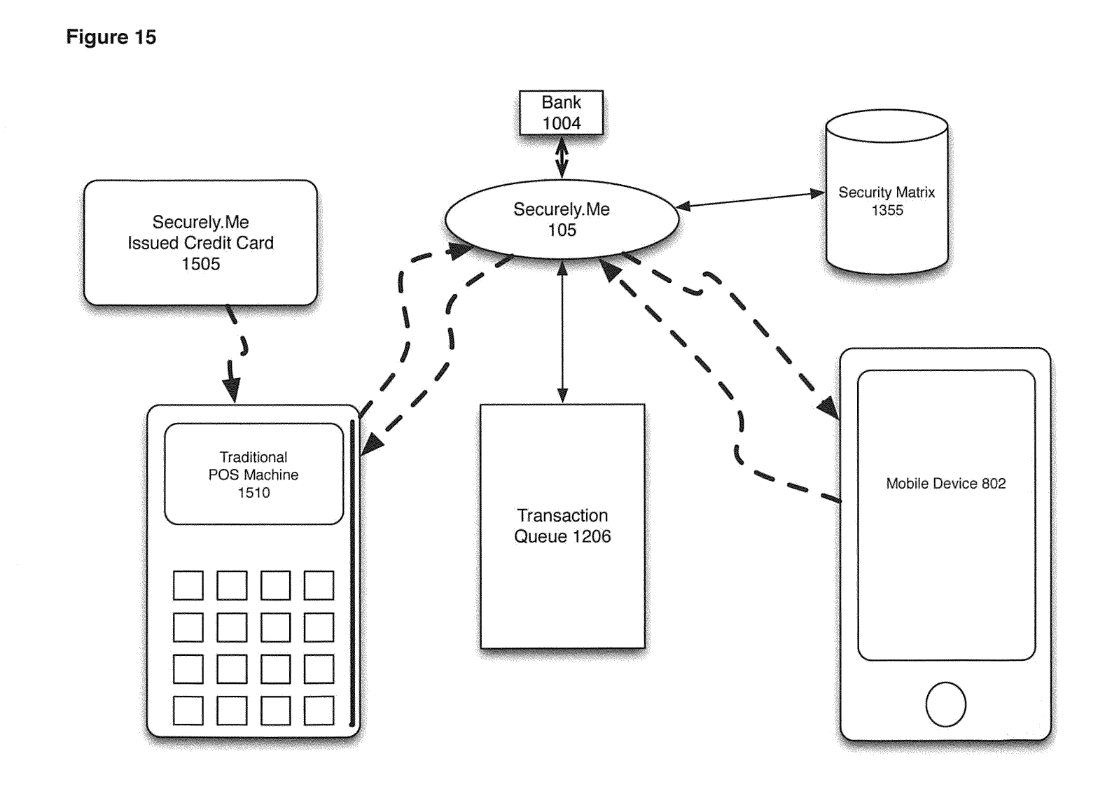

Referring now to FIG. 15, a block diagram of a transaction flow illustrating the transaction queue of the present invention is show. As explained with reference to FIG. 12, the process begins when a transaction is requested. This request could be initiated in response to a card swipe of a InspirePay credit card 1505 on a traditional POS machine 1510, submitted online (not shown) or it could also be a merchant initiated transaction. In each case, the transaction request is sent to the InspirePay transaction engine 105. The InspirePay transaction engine 105 retrieves any Customer or, if applicable, Merchant configuration rules (such as those illustrated in FIG. 14) and either requests further input from the traditional POS 1510 or sends one or more authorization requests to the mobile or other device associated with the primary cardholder.

As explained above, the sequence could involve submitting a code, performing an action, verifying one or more stored biometric data fields or any number of other additional sequencing steps. It could also be that the transaction may be below any thresholds that require any approval and the transaction can be approved outright. A third alternative is that the transaction does require additional approvals and the primary cardholder is not present in order to validate that approval. As explained above, this would occur if any user other than the primary cardholder initiated a transaction and the transaction had not been configured for automatic approval. In such case, the transaction would be added to the transaction queue 1206 and will be held in pending for some period of time. If the transaction were at a traditional store (such as a clothing store)_pendency and approval period could be very short—as little as ten minutes. Alternatively, the transaction could pend for days until approved such as might be the case for if an automatic payment (such as a utility bill) were submitted by the merchant for processing. In such cases, the approval for each transaction would still need to include performance of the authorization sequence associated with customer settings in the security matrix 1355 before the transaction could be removed from the queue by the InspirePay transaction engine 105 and ultimately the transaction request send to the bank 1004 or other financial institution for ultimate processing. In this way, the customer always has ultimate control now over the means for validating their identity, approving the transaction (whether at the time or following some delay on the transaction queue 1206) as well as which accounts are leveraged to complete the transaction.

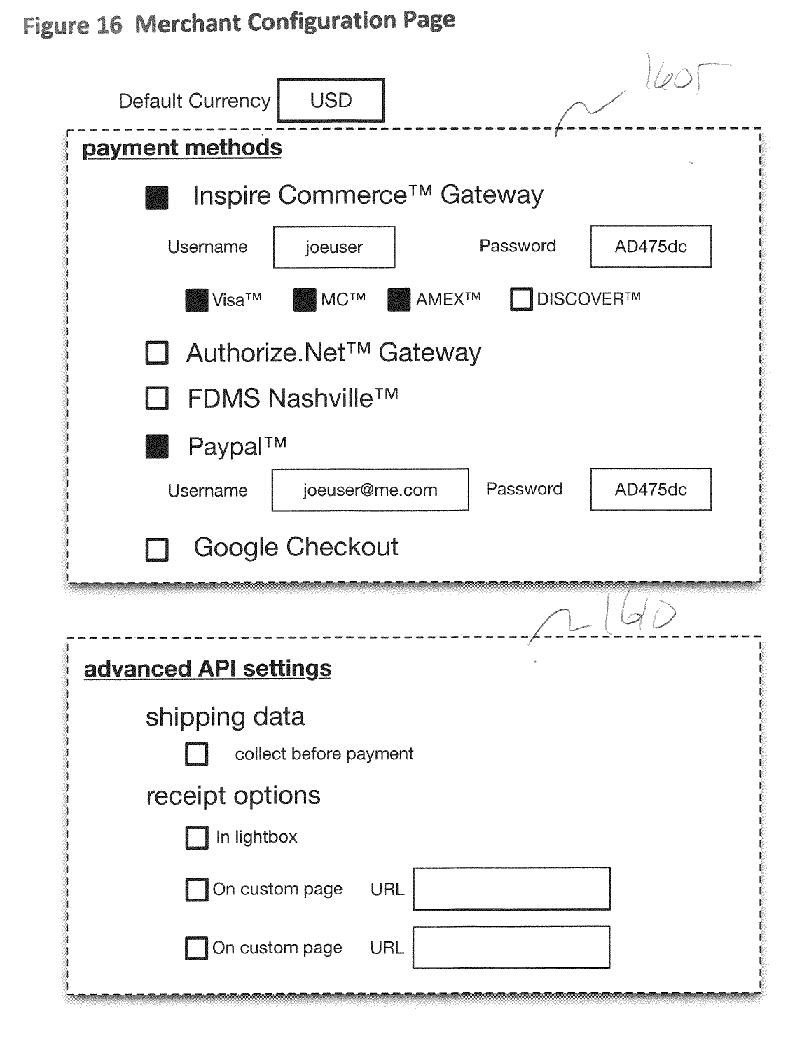

Referring now to FIG. 16, a sample merchant configuration page is shown. The configuration page is comprised of two primary components: payment methods 1605 and advance API settings 1610. Payment method 1605 provides an interface to the type of payments that a merchant is willing to receive. As explained above, different payment methods may include different transaction fees and requirements so merchants can choose which of the payment vendors terms they are willing to accept and to provide username and password or other authentication information required to leverage that account. The availability of these accounts is then stored in the merchant configuration file. Furthermore, merchants can elect to accept different payments depending on the risk profile of the consumer (not shown). For example, consumers with a high-risk profile could be required to provide a credit card payment rather than an e-check. The riskiness of the profile may also dictate whether the merchant elects to pay, subsidize or pass-thru the transactional charges. In this way, lower risk—“better” consumers—are given preferred rates and terms.

This configuration and payment information is then used to generate a payment page in response to either a payment request (merchant initiated) or a payment offer (user initiated). In the preferred embodiment, a server (not shown) would include the functions described throughout this application—namely a script-based on other HTML5 webpage—that can support the authentication of a consumer in response to consumer selection of one or more payment options permitted buy the merchant. For example, a simple log-in page for paypal may be initiated if the consumer requested that they use paypal. Alternatively, the consumer may select one or more payment methods in which case the payment page may include several different user names, passwords, or other authentication features as described above. The consumer would then enter any payment information and “submit” payment to the merchant in accordance with the merchant's payment configuration 1605 preferences.

While it is now shown in this figure, a further refinement of the payment methods 1605 configuration would be to have a further screen illustrating the respective transaction rates and cost burden for the merchant. This could be based on information already entered into the system and mapped to that payment method for large payment processing system or may be based on collecting information, such as via one or more online spiders, that track, monitor and scrape transactional fee information from one or more respective payment processor. Merchant configuration 1600 is also comprised at advanced API settings 1610. These are the settings that may be required by one or more payment processors or an optional requirement that the merchant wishes to insert into the overall payment process. For example, a merchant may require shipping data prior to payment processing to make sure that they have an effective shipping address. Further configurations would permit different types of receipts 1610 or other types of interface driven configurations.

As one skilled in the art would appreciate, there are an unlimited number of “pre payment” options that could be employed in connection with the payment entry and submission including things like satisfaction surveys, referral information or other types of “non-payment” information that could precede final processing.

It is important to note that while this invention was described with reference to a customer and merchant, any transaction involving a privilege that can only be granted to an authorized party could leverage this system. This includes access to services, information or other forms of electronic transactions that do not necessarily involve money but do involve a privilege of some type or another. Furthermore, these examples are intended merely to illustrate one embodiment of the invention. It would be obvious to one skilled in the art that any number of means for authentication, personalization, transactional cost splitting and risk algorithms could be applied to the financial accounts linked to the InspirePay server 105.

Finally, while many of the mobile screen shots were illustrated as requesting approval of a transaction, the steps that could be employed to request mobile payment could range from near field communications, wireless transactions, SMS requests, QR codes or any other manner of receiving a request for payment currently contemplated on a mobile phone could be leveraged to achieve a request for payment.

I claim:

1) A system for enabling customized financial transactions by a consumer on a merchant website via an open architecture, comprising:
a) a user registration page for permitting a user to register information regarding financial accounts linked to the consumer;
b) logically connected thereto, a security configuration page for enabling the user to provide authentication information for each financial account and to configure one or more personalized security filters associated with each registered financial account;
c) logically connected thereto, an authentication server for storing the registered financial account information, authentication information and personalized security filters;
d) logically connected thereto, a payment server capable of
i. authenticating the user with one or more of the registered financial accounts using the personalized security filters and authentication information provided by the user in response to a payment request;
ii. processing one or more financial transaction(s) using one or more financial accounts linked to the user; and
iii. generating a transaction ID to identify the customer and the associated financial transaction(s).

2) The system of claim 1, wherein the user registration page permits the user to enter bank account information.

3) The system of claim 1, wherein the security configuration page includes functions that permit configuration of security filters that require a user to enter additional passwords before permitting use of associated financial account.

4) The system of claim 1, wherein the security configuration page includes functions that permit configuration security filters that require a user to enter OpenID passwords before an associated financial account can be used.

5) The system of claim 4, wherein the openID password is a password that can be used to access a Google™ account.

6) The system of claim 4, wherein the OpenID password is a password that can be used to access a Facebook™ account.

7) The system of claim 1, wherein the security configuration page permits configuration of a security filter that requires a user to be at a specific location in before permitting use of an associated financial account.

8) The system of claim 1, wherein the security configuration page permits configuration of a security filter that requires a user to be using a specific device before permitting use of an associated financial account.

9) The system of claim 1, wherein the security configuration page permits configuration of a security filter that requires the merchant to be at a specific location before permitting use of an associated financial account.

10) The system of claim 1, wherein the security configuration page permits configuration of a security filter that requires the requested transaction to be below a certain dollar amount before permitting use of an associated financial account.

11) A system for enabling customized financial transactions by a merchant via an open architecture, comprising:
a. A merchant registration page for entering merchant financial information including any banking or merchant bank accounts associated with the merchant;
b. Logically connected thereto, a merchant configuration page for configuring one or more customer payment configuration options in relation to payment processors and merchant bank accounts;
c. a script file, in communication with such merchant configuration page, for retrieving one or more resources for supporting the payment options selected by the merchant;
d. Logically connected thereto, a web server that is configured to store and transmit resources requested by the script file;
e. Logically connected thereto, a payment page, that includes any software resources retrieved by the script file, for enabling a consumer to enter and submit payment information consistent with the merchant payment configuration options; and
f. Logically connected thereto, a payment server for processing a payment in response to submission of payment information by a consumer consistent with the merchant payment configuration options.

12) The system of claim 11, wherein the merchant configuration page includes options allowing the merchant to restrict payment options based on one or more attributes of the consumer.

13) The system of claim 12, wherein the merchant configuration page includes options allowing the merchant to restrict payment options based on one or more attributes of the consumer wherein the attribute is the age of the consumer.

14) The system of claim 12, wherein the merchant configuration page includes options allowing the merchant to restrict payment options based on one or more attributes of the consumer wherein the attribute is the credit score of the consumer.

15) The system of claim 12, wherein the merchant configuration page includes options allowing the merchant to restrict payment options based on one or more attributes of the consumer wherein the attribute is the type of financial account used by the consumer.

16) The system of claim 12, wherein the merchant configuration page includes options allowing the merchant to restrict payment options based on one or more attributes of the consumer wherein the attribute is the frequency of purchases by the consumer.

17) The system of claim 12, wherein the payment page includes an option that permits the consumer to agree to pay any transaction fees.

18) The system of claim 16, wherein the payment page includes software resources that permit access to additional payment options in response to consumer's agreement to pay any transaction fees.

19) A method for enabling user configured financial transactions comprising the steps of:
a. In response to a user request, transmitting a user registration page that permits a user to register account information regarding one or more financial accounts linked to the consumer;
b. in response to a user submission of a registration page, assigning the user an identifier (ID);
c. transmitting a security configuration page for enabling the user to configure one or more transaction filters and link the selected filters with one or more of the registered financial accounts;
d. receiving a transaction request from a user that includes a user ID;
e. retrieving a list of financial accounts linked to the user ID that are permitted for the requested transaction;
f. permitting the user to select one or more financial accounts;
g. In response to user selection of a financial account linked to the user ID, presenting the user with an authentication request that requires the user to perform actions to satisfy the security filters that have linked to that financial account; and
h. In response to correctly entering the authentication information or other requirements of each security filter linked to the financial account, performing the transaction requested by the user.

20) The method of claim, 19, wherein the step of receiving a transaction request includes receiving a transaction request that has been initiated at a point of service (POS) terminal using a financial card.

21) The method of claim 19, wherein the step of presenting the user with an authentication request includes sending an authentication request to a mobile phone linked to the user ID

22) The Method of claim 19, wherein the step of receiving a financial requested linked to the User ID includes receiving a card number from a debit card used at the POS terminal.

23) The method of claim 19, wherein the debit card is linked to more than one financial account.

24) The method of claim 19, wherein the step of selecting a financial account occurs before the requested transaction and is based on the balances of one or more financial accounts linked to the debit card.

25) The method of claim 23, wherein the step of selecting a financial account occurs before the requested transaction and is based on the type of transaction that is being requested.

26) The method of claim 25, wherein step of selecting a financial account occurs before the requested transaction and is based on the size of transaction that is being requested.

27) A method for processing a payment comprising the steps of:
a. receiving a user ID linked to one or more financial accounts and authentication requirements in a database;
b. Prompting the user to submit one or more fields of authentication information based on the authentication requirements;
c. In response to correct entry of the authentication information for at least one financial account, providing a user with an option to add an escrow to the financial account(s) that were user authenticated;
d. In response to user selection of the escrow option, prompting the user to enter one or more attributes that would trigger the creation of the escrow;
e. In response to the entry of at least one criteria for that would trigger creation of an escrow, prompting the user to enter at least one attribute that would trigger release of the escrow; and
f. Adding at least one field in the database linked to the financial account that has an escrow option that includes the attributes that would trigger creation of an escrow and the attributes hat would trigger release of that escrow.

28) The method of claim 27, further comprising the steps of:
a. Receiving a request for a financial transaction that includes the request to transfer funds from at least one financial account that has an escrow option to a third party account;
b. Retrieving the attributes linked to that financial account that would trigger creation of an escrow;
c. Determining if the requested financial transactions meets one or more of the attributes identified as triggering creation of an escrow; and
d. In response to meeting at least one attribute that the user has identified that would trigger creation of an escrow, creating an escrow account; and
e. Transferring the funds identified in the requested financial transaction to the escrow account.

29) The method of claim 28, further comprising the steps of:
a. Retrieving one or more attributes that the user for releasing the escrow; and
b. Determining if one or more of the attributes for releasing the escrow have been met; and
c. Following a determination that the attributes have been met, transferring the funds in the escrow to the third party account identified in the original request for a financial transaction.
